(19) United States
(12) Patent Application Publication
(10) Pub. No.: US 2015/0211799 A1
(43) Pub. Date: Jul. 30, 2015

(54) WORKPIECE SUPPORT

(71) Applicant: SGL CARBON SE, WIESBADEN (DE)

(72) Inventors: FRANK EISELT, MEITINGEN (DE); THOMAS STEINER, MEITINGEN (DE)

(21) Appl. No.: 14/683,353

(22) Filed: Apr. 10, 2015

Related U.S. Application Data
(63) Continuation of application No. PCT/EP2013/071090, filed on Oct. 9, 2013.

(30) Foreign Application Priority Data
Oct. 10, 2012 (DE) 102012218491.0

(51) Int. Cl. F27D 5/00

(52) U.S. Cl. CPC F27D 5/0006

(57) ABSTRACT

A workpiece support contains at least two component elements which are respectively made from a carbon-fiber reinforced carbon (CFC). At least two of the at least two CFC component elements are locked together. The workpiece supports use simple measures and in such a way that undesirable release of the individual component elements is reliably prevented.

### CROSS-REFERENCE TO RELATED APPLICATION

This is a continuation application, under 35 U.S.C. §120, of copending international application No. PCT/EP2013/071090, filed Oct. 9, 2013, which designated the United States; this application also claims the priority, under 35 U.S.C. §119, of German patent application No. DE 10 2012 218 491.0, filed Oct. 10, 2012; the prior applications are herewith incorporated by reference in their entireties.

### BACKGROUND OF THE INVENTION

### Field of the Invention

The present invention relates to a workpiece support containing at least two component elements which are each composed of a carbon fiber reinforced carbon (CFC).

Workpiece supports made of CFC are used to support or hold workpieces in high-temperature environments. For example, what are known as charging racks are used as supports when workpieces are hardened or sintered in industrial furnaces, whereby, in the simplest case, the workpieces to be subjected to heat treatment are placed on a supporting surface of the charging rack. Workpiece supports made of CFC are distinguished with respect to steel workpiece supports in particular on account of their increased temperature resistance and better dimensional stability.

Assembling a workpiece support from a plurality of component elements is advantageous in terms of both production costs and flexibility. In particular, this makes it possible to build complex racks which are tailored to the respective type and number of workpieces. The individual component elements can, for example, be fitted together by frictional connection elements. German utility model DE 295 12 569 U1, for example, discloses a workpiece support for pieces to be hardened which is constructed from four CFC bars fitted together in the manner of a frame.

However, in such workpiece supports formed of CFC component elements which have been fitted together, the problem exists whereby the frictional connection elements in question, such as guide ribs and guide grooves, have to be produced with a relatively high degree of precision in order to prevent both an undesirably loose connection and jamming of the component elements when they are fitted together, and this is associated with a very complex and costly production process. In addition, owing to the high temperatures and the marked temperature differences during a hardening or sintering process, the frictional connection may release and the workpiece support as a whole may be subject to undesirable deformation as a result. To prevent two connected component elements from releasing from one another in such an undesirable manner, the component elements can be bonded together, although this again entails a more complex production process.

### SUMMARY OF THE INVENTION

It is therefore an object of the present invention to develop workpiece supports of the type mentioned at the outset using simple measures and in such a way that undesirable release of the individual component elements is reliably prevented.

The object is achieved by a workpiece support having the features of the main claim.

According to the invention, at least two of the at least two CFC component elements are latched together. In latching of this type, at least two corresponding latching teeth elements interlock and hold the two CFC component elements in a defined latched position, while it is possible to release the interlocking at least in one direction by the application of force. In other words, when the component elements are fitted together and, if applicable, separated, the teeth elements can slide past one another. In a latch connection or click connection of this type, it is often possible to tell by sound and/or touch that the latched position has been reached (“click-in” or “snap-in”).

The two CFC component elements are thus not only fitted together and thus frictionally connected, but, owing to the latching, there is also an interlocking connection which increases the stability of the component as a whole and prevents undesirable loosening or releasing of the individual components. Complex bonding is not required in this case. Owing to the increase in the load capacity of the connection as a result of the interlocking, material can be saved when configuring the component elements, thus reducing production costs.

Rigid, interlocking connections in the form of undercuts or pinned fittings often require the component elements to be assembled in a complicated manner from various directions and in a specific order. By contrast, it is possible to latch together two component elements in a particularly quick and simple manner. Moreover, only relatively few demands are placed on a latch connection in terms of dimensional accuracy. It is thus possible in particular to provide workpiece support kits which can be used by end clients to produce custom workpiece supports, depending on the respective application, by simply clicking together the individual parts.

Preferably, the latching between the at least two CFC component elements can be released by overcoming a latching resistance. The workpiece support can then be taken apart as required in a simple manner.

According to an embodiment of the invention, the force to be exerted, as a minimum, on one of the two CFC component elements in order to overcome the latching resistance is at least 10 N. An adapted latching resistance both ensures sufficiently high protection against unintentional release of the latch connection and allows the workpiece support to be assembled and disassembled in a simple manner. If there is no intention to subsequently dismantle the workpiece support, the latching resistance can also be configured to be so large as to practically exclude the possibility of the latch releasing without causing destruction.

According to an embodiment of the invention, the workpiece support can also contain at least three CFC component elements, each of the at least three CFC component elements being latched to at least one other of the at least three CFC component elements. This allows relatively complex workpiece supports to be built, the individual component elements being reliably held together by the mutual latching. For example, a workpiece support can contain two CFC component elements which are configured as longitudinal supports, are arranged in parallel with one another and are engaged from above by at least one CFC component element formed as a transverse support, the transverse support being latched at either end to one of the longitudinal supports. This makes it possible in particular to build a grate-like or grid-like workpiece support which is suitable for supporting a plurality of different workpieces.

To allow workpieces to be held in a simple and reliable manner, a supporting surface for a workpiece can be formed on at least one of the at least two CFC component elements and preferably on each of the at least two CFC component elements. Depending on the application, however, special fixing elements, such as recesses or brackets, which engage from above the workpiece to be held can also be provided on the CFC component elements. It may also be advantageous in some applications to provide separate supporting or holding elements, made of ceramic for example, which are connected to the CFC component elements.

A latching projection can be provided on at least one of the at least two CFC component elements which are latched together, and engages in a latching socket provided in another of the at least two CFC component elements which are latched together. The latching projection can be any material region which protrudes from a basic surface of the CFC component element, for example a planar wall. According to the application, a latching projection of this type can be in the shape of a tooth, a bulge or a lug. The latching projection is preferably configured as a ramp in order to provide a starting bevel for facilitating the latching. In principle, the latching projection can be configured as a separate component element, although it is preferable for the latching projection to be shaped integrally directly on the associated CFC component element.

It can be provided for the latching projection to protrude by a distance of between 0.05 mm and 1.5 mm, preferably between 0.1 mm and 0.7 mm, and most preferably between 0.2 mm and 0.4 mm from the basic surface of the associated CFC component element. Distances of this size have proven to be particularly favorable in that, on one hand, a secure latch connection is ensured while, on the other hand, one CFC component element can be latched or clicked into the other CFC component element in a simple manner.

According to a particular embodiment of the invention, a latching projection and a latching socket are provided on each of the at least two CFC component elements which are latched together, the latching projections and the latching sockets of each two CFC component elements which are latched together engaging with one another. The construction of the workpiece support is simplified as a result. In particular, care does not have to be taken during assembly to provide a sufficient number of CFC component elements having latching projections or CFC component elements having latching sockets, since a latching socket is always provided for each latching projection. In this way, it is possible to build various workpiece supports from one limited set of basic elements in the manner of a modular system.

Another aspect of the invention provides that the at least two CFC component elements can be fitted together in an insertion direction for the purpose of latching, the latching projection and the latching socket of each of the at least two CFC component elements being arranged one behind the other in relation to the insertion direction. When the CFC component elements are fitted together in the insertion direction, the latching projection on one CFC component element thus automatically enters the latching socket in the other CFC component element and vice versa, making particularly simple latching possible.

At least one of the at least two CFC component elements which are latched together can have a groove for receiving an insertion portion of the other CFC component element, the latching projection projecting from a side wall of the groove. The insertion portion can be any region of the CFC component element in question, of which the width is adapted to the width of the groove. The groove is then both used as a guide for the CFC component element to be inserted and provides the latching projection used for latching.

Respective latching projections can also project from two opposing side walls of the groove, it thereby being possible to increase the stability of the latch connection.

According to a specific embodiment of the invention, the at least two CFC component elements which are latched together are plate-like and each have at least one groove, the grooves interlocking with one another. Such CFC component elements are relatively simple to produce and are particularly suitable for constructing grid-like charging racks.

In particular, the groove can have a rectangular cross section, which allows for particularly simple production.

Another embodiment of the invention provides that at least one of the at least two CFC component elements which are latched together and preferably each of the at least two CFC component elements which are latched together have at least three spaced-apart grooves for receiving an insertion portion of another CFC component element. As a result, it is possible to further increase the flexibility, during construction, of an application-specific workpiece support.

It can be provided for two parallel, spaced-apart channels to be formed in at least one side wall of the groove, between which channels extends the in particular plateau-like or bulge-like latching projection. Configuring the latching projection in this way has proven to be advantageous in terms of simplicity of latching.

The channels can have a round cross section, the radius of curvature of the rounded portion being at least 0.1 mm and preferably at least 0.3 mm.

Furthermore, a ramp-like latching projection and a channel adjacent thereto can also be formed in at least one side wall of the groove. The channel makes it easier to latch or click the latching projection into the associated latching socket.

Preferably, the at least two CFC component elements are each composed of a carbon fiber reinforced carbon containing carbonized and/or graphitized polyacrylonitrile fibers. Fibers of this type have produced particularly good results.

It is also preferable for the at least two CFC component elements to each be formed of a carbon reinforced with continuous carbon fibers, discontinuous carbon fibers and/or stretch-broken fibers.

It is preferable in terms of fiber thickness for the at least two CFC component elements to each be composed of a carbon fiber reinforced carbon containing carbon fibers having an average diameter of between 5 μm and 10 μm. Approximately 7 μm has proven to be a particularly advantageous average carbon fiber diameter.

In relation to the fiber content of the CFC component elements, it has proven advantageous for the at least two CFC component elements to each be composed of a carbon fiber reinforced carbon containing at least 30 vol. %, preferably at least 50 vol. %, and most preferably at least 70 vol. % carbon fibers.

To ensure reliable use of the workpiece support during hardening or sintering, it is preferable for the at least two CFC component elements to have a temperature resistance of at least 1500° C. and preferably of at least 2500° C.

The workpiece support can be assembled exclusively from CFC component elements that are preferably identical. This allows for particularly cost-effective production.

Preferably, the workpiece support is at least 50 mm×50 mm×10 mm (W×L×H), preferably at least 100 mm×100 mm×10 mm, and most preferably at least 300 mm×300 mm×20 mm, for example 1200 mm×1200 mm×50 mm. Workpiece supports of this size are typically used as charging racks when hardening or sintering components.

The present invention also relates to the use of an above-described workpiece support as a charging rack in a high-temperature environment.

Other features which are considered as characteristic for the invention are set forth in the appended claims.

Although the invention is illustrated and described herein as embodied in a workpiece support, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a CFC component element for a workpiece support according to a first embodiment of the invention;

FIG. 2 is an enlarged partial plan view of the workpiece support according to FIG. 1;

FIG. 3 is a partial plan view of a CFC component element for a workpiece support according to a second embodiment of the invention; and

FIG. 4 is a partial plan view of a CFC component element for a workpiece support according to a third embodiment of the invention

### DETAILED DESCRIPTION OF THE INVENTION

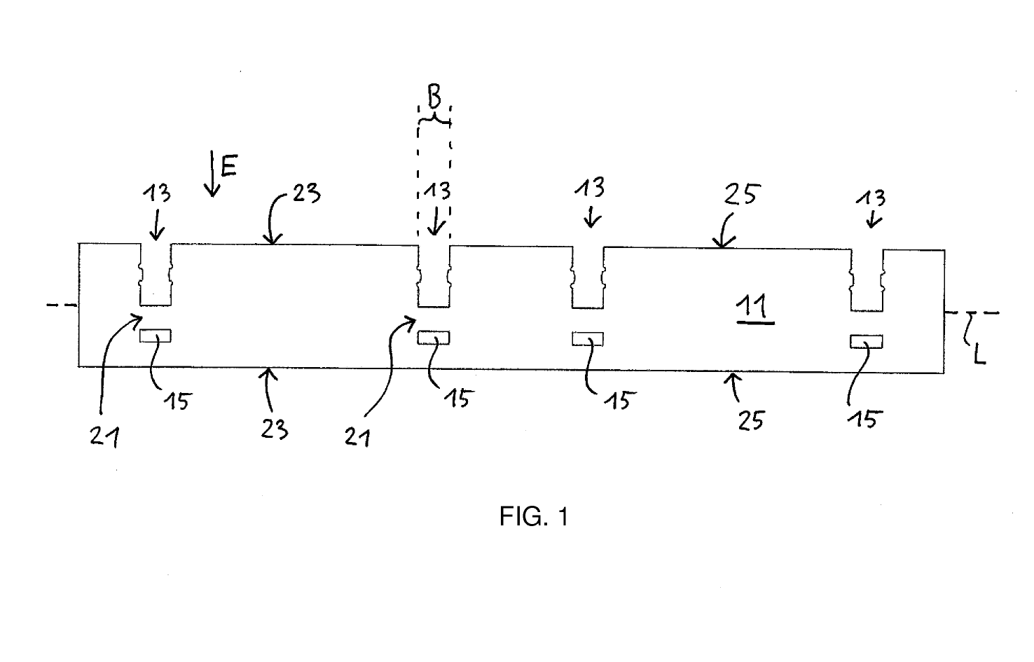

Referring now to the figures of the drawings in detail and first, particularly to FIG. 1 thereof, there is shown a plate-shaped component element 11 that is produced completely from a carbon fiber reinforced carbon (CFC) and is used to construct a workpiece support, such as a charging rack. The carbon fiber reinforced carbon contains continuous fibers made of carbonized and/or graphitized polyacrylonitrile which are embedded in a carbon matrix in an amount of at least 80 vol. %. Preferably the fibers have an average diameter of approximately 7 μm.

As shown, the CFC component element 11 is in the form of an elongate bar and has a longitudinal axis L. Four grooves 13 of rectangular cross section are formed in the CFC component element 11 at a spacing from one another along the longitudinal axis L. A width B of each of the grooves corresponds to a thickness (not visible in FIG. 1) of the plate-shaped CFC component element 11. In addition, the CFC component element 11 has four rectangular recesses 15 which are each arranged so as to be adjacent to the groove 13 and have a width which corresponds to the width B of the grooves 13.

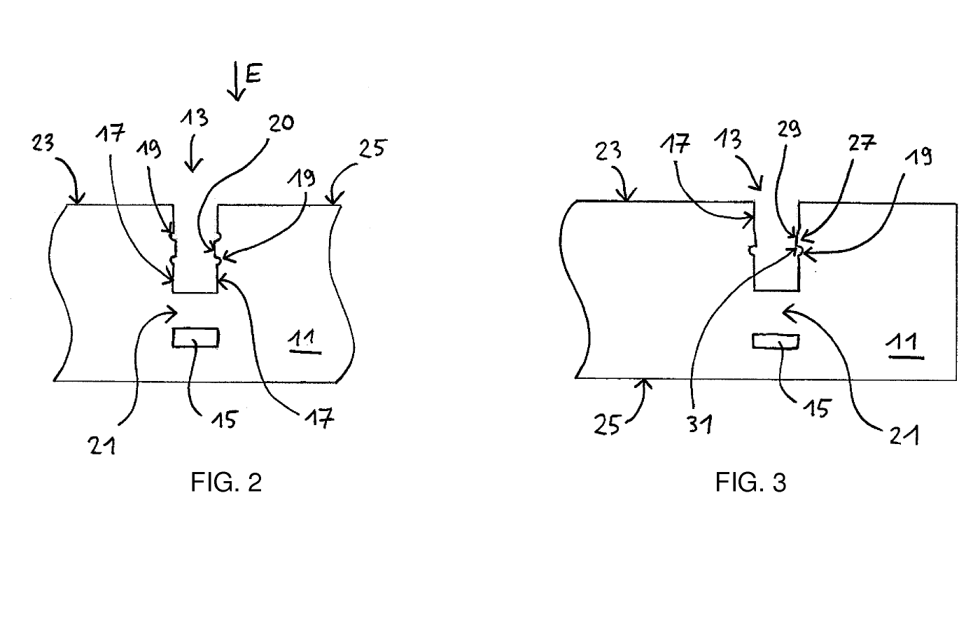

As is particularly clear from the enlarged view according to FIG. 2, each groove 13 has two opposing side walls 17, two parallel channels 19, which are spaced apart from one another transversely to the longitudinal axis L, being formed in each side wall 17. Between each of the two channels 19 of the side wall 17 there is a slightly rounded latching bulge 20 which protrudes from the surface of the side wall 17 by approximately 0.35 mm.

As will be described in more detail below, in each case two CFC component elements 11, formed in accordance with FIG. 1, can be latched together using the grooves 13, the recesses 15 and the latching bulges 20. In this case, the two CFC component elements 11 to be connected are first arranged in a manner known in principle, such that longitudinal axes L thereof extend at right angles to one another and the groove 13 in the top of one CFC component element 11 is opposite a groove 13 in the bottom of the other CFC component element 11. The two CFC component elements 11 are then fitted together in an insertion direction E which points transversely to the two longitudinal axes L, the grooves 13 interlocking with one another. The region, located to the side of the groove 13 when viewed in the direction of the longitudinal axis L, of a CFC component element 11 thus forms an insertion portion 21 which is guided through the groove 13 of the other CFC component element 11 and which, when the component elements are fitted together, slides past the latching bulge 20, the bulge being elastically deformed in the process. As soon as the recesses 15 arrive at the latching bulges 20, the pretensioned latching bulges 20 latch into the recesses 15, as a result of which the two CFC component elements 11 are latched together. The CFC component elements 11 can now only be released from one another counter to the insertion direction E by overcoming a latching resistance using an increased amount of force. The latching resistance can be adapted in a relatively precise manner to a predetermined value, determined by the application, by means of the shape and size of the latching bulge 20 and by the selected material. By using three or more CFC component elements 11, it is possible to construct, simply and in the manner described above, frame-like or grid-like workpiece supports in which the narrow sides 23 of the CFC component elements 11 form respective supporting surfaces 25 for workpieces. Workpiece supports of this type are particularly suitable as charging racks in hardening or sintering furnaces. Since the associated component elements 11 are produced exclusively from CFC, sufficient temperature resistance and dimensional stability are ensured.

Assembling a workpiece support by latching the CFC component elements 11 together is simple and does not require any specialist knowledge. The respective end client can thus also carry out the assembly, while the manufacturer of the workpiece supports merely provides a set of CFC component elements 11, to be fitted together individually, as a kit. A particular advantage of the described system is that there are no undercuts which require both different insertion directions to be taken into account and a particular order to be followed when fitting together during assembly. There is also no need for either bonds or separate fastening elements such as pegs or pins since the stability of the CFC component element group is ensured by the latching.

FIG. 3 shows an alternative embodiment of a CFC component element 11 according to the invention, a latching lug 27 having a ramp portion 29 and a shoulder 31 being provided in this case instead of a latching bulge. Adjacent to the shoulder 31 there is a single channel 19. The ramp portion 29 of the latching lug 27 forms a starting bevel for the insertion portion 21 of the other CFC component element 11 and thus makes it easier to fit the two CFC component elements 11 together. In this case, the shoulder 31 provides a higher latching resistance than in the embodiment according to FIGS. 1 and 2.

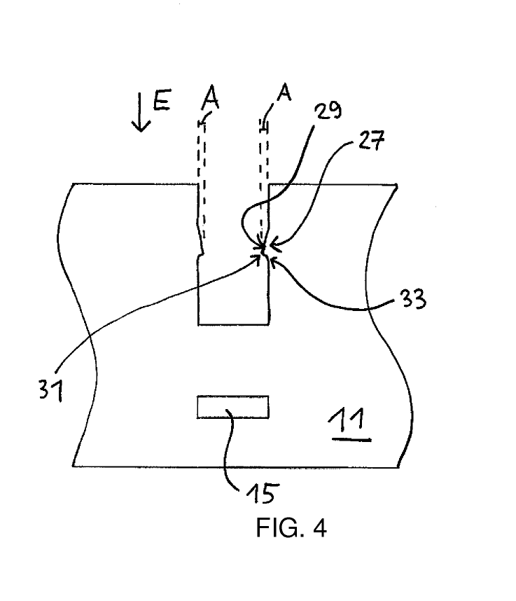

FIG. 4 shows another embodiment of the invention. As with the embodiment according to FIG. 3, the latching lug 27 is provided for latching into the recess 15, although no channel is formed in the side wall 17 of the groove 13. In this case, the shoulder 31 instead extends in a rounded portion 33. In FIG. 4, a distance A by which the latching lug 27 projects from the side wall 17 is marked by dashed lines.

Unlike when the CFC component elements 11 are nested into each other in a purely frictional manner, latching allows not only for better stability, but also for simpler assembly.

The following is a summary list of reference numerals and the corresponding structure used in the above description of the invention:
11 component element
13 groove
15 recess/latching socket
17 side wall/basic surface
19 channel
20 latching bulge/latching projection
21 insertion portion
23 narrow side
25 supporting surface
27 latching lug/latching projection
29 ramp portion
31 shoulder
33 rounded portion
L longitudinal axis
B width
E insertion direction
A distance

1. A workpiece support, comprising:
at least two component elements each composed of a carbon fiber reinforced carbon (CFC), at least two of said at least two CFC component elements are latched together.

2. The workpiece support according to claim 1, wherein a latching between said at least two CFC component elements can be released by overcoming a latching resistance.

3. The workpiece support according to claim 1, wherein said at least two component elements are two of at least three CFC component elements, each of said at least three CFC component elements being latched to at least one other of said at least three CFC component elements.

4. The workpiece support according to claim 1, further comprising:
a latching socket formed in at least one of said at least two CFC component elements; and
a latching projection disposed on at least one of said at least two CFC component elements which are latched together, said latching projection engaging in said latching socket provided in another of said at least two CFC component elements which are latched together.

5. The workpiece support according to claim 4, wherein said latching projection is ramp-shaped.

6. The workpiece support according to claim 4, wherein said latching projection protrudes by a distance of between 0.05 mm and 1.5 mm from a surface of said CFC component element.

7. The workpiece support according to claim 1, further comprising:
latching sockets; and
latching projections, one of said latching projection and one of said latching sockets are disposed on each of said at least two CFC component elements which are latched together, said latching projections and said latching sockets of each of said two CFC component elements which are latched together engaging with one another.

8. The workpiece support according to claim 7, wherein said at least two CFC component elements can be fitted together in an insertion direction for a purpose of latching, said latching projection and said latching socket of each of said at least two CFC component elements being disposed one behind the other in relation to the insertion direction.

9. The workpiece support according to claim 4, wherein:
said at least two CFC component elements each having an insertion portion; and
at least one of said at least two CFC component elements which are latched together has a groove formed therein for receiving said insertion portion of said other CFC component element, said latching projection projecting from a side wall of said groove.

10. The workpiece support according to claim 9, wherein said latching projection is one of two latching projections projecting from two opposing side walls of said groove.

11. The workpiece support according to claim 9, wherein said at least two CFC component elements which are latched together are plate-shaped and each have said groove, said groove of each of said at two CFC component elements interlocking with one another.

12. The workpiece support according to claim 9, wherein at least one of said at least two CFC component elements which are latched together have at least three spaced-apart grooves formed therein for receiving said insertion portion of another of said CFC component elements.

13. The workpiece support according to claim 9, wherein two parallel, spaced-apart channels are formed in at least one side wall of said groove, between which said channels extends said latching projection being selected from the group consisting of a plateau-shaped latching projection and a bulge-shaped latching projection.

14. The workpiece support according to claim 9, wherein:
said latching projection is a ramp-shaped latching projection; and
said at least one of said two CFC component elements has a channel adjacent to said ramp-shaped latching projection formed in at least one side wall defining said groove.

15. The workpiece support according to claim 4, wherein said latching projection protrudes by a distance of between 0.1 mm and 0.7 mm from a surface of an associated one of said CFC component elements.

16. The workpiece support according to claim 4, wherein said latching projection protrudes by a distance of between 0.2 mm and 0.4 mm from a surface of an associated one of said CFC component elements.

17. The workpiece support according to claim 9, wherein each of said at least two CFC component elements which are latched together each have at least three spaced-apart grooves formed therein for receiving said insertion portion of another of said CFC component elements.

18. A charging rack for a high-temperature environment, comprising:
a workpiece support having at least two component elements each composed of a carbon fiber reinforced carbon (CFC), at least two of said CFC component elements are latched together.
